(19) United States
(12) Patent Application Publication
(10) Pub. No.: US 2006/0149664 A1
(43) Pub. Date: Jul. 6, 2006

(54) Marketing system and method

(75) Inventors: Andrew Smyth, Delaware, OH (US); Christopher A. Russo, South Euclid, OH (US); Kevin Noel Cron, Galloway, OH (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: JP Morgan Chase Bank, New York, NY (US)

(21) Appl. No.: 11/063,862

(22) Filed: Feb. 24, 2005

Related U.S. Application Data
(60) Provisional application No. 60/640,059, filed on Dec. 30, 2004.

(51) Int. Cl. G06Q 40/00

(52) U.S. Cl. 705/38

(57) ABSTRACT

Disclosed herein are exemplary techniques for and of marketing a loan product to a customer. The system and method establish communication with a customer regarding a current loan; access a customer service module; inputting loan information provided by the customer into the customer service module; displaying a plurality potential loan options.

### CROSS-REFERENCE TO RELATED APPLICATIONS

The present invention claims benefit of U.S. Patent Application No. 60/640,059 (Client Reference: Attorney Docket No.: 47004.000316) filed Dec. 30, 2004 and entitled “Marketing System And Method,” the entirety of which is incorporated by reference herein.

### BACKGROUND OF THE INVENTION

1. Field of the Invention

This invention relates to a system and method for marketing loan products to customers, specifically to a system and method for quickly accessing and presenting loan products.

2. Description of Related Art

Customer care is a vital part of modern business. Many businesses, such as financial service providers, or other service related businesses must maintain a robust customer care capabilities. Customer care enables companies to strengthen customer relationship. Companies often rely on computer assisted tools to facilitate interaction between the customer and the company.

There are several shortcomings of such customer care tools such as a lack of streamlining; possibility of errors; lack of effective targeted product offerings; inefficiencies that reduce the time available to focus on meeting a customers needs. By way of example, a customer care representative has a limited amount of time in which they can keep a customer on the phone. Failure to quickly identify and present cross-selling and marketing opportunities to the customer may result in either: losing the customer call before marketing can occur; or holding the customer on the line for a long period of time which upsets the customer and reduces the likelihood of a successful cross-sell.

Another shortcoming of customer care tools is a lack of consistency and transparency between different applications. For example, a customer care representative may be closing an existing loan. The representative may cross-sell another loan to the customer. If the systems are not properly linked the representative may be forced to ask the customers questions regarding the new loan that were already answer with regard to the old loan. Additionally, information may need to be rekeyed when each new product is marketed to the customer.

Another shortcoming of customer care tools is they lack the ability to quickly present a “what if” analysis. For example, the representative may be unable to quickly and effectively present several products a using real data that is personalized to the customer.

Another shortcoming of customer care tools is they lack the ability to enter and close on a loan product in the same call that the cross-sell or marketing was initiated.

Other drawbacks may also exist.

### SUMMARY OF THE INVENTION

It is therefore desirable that the invention overcome these and other drawbacks of present systems and methods. Thus there is a need to provide a system and method for marketing and cross-selling to customers. To achieve this invention, as embodied and broadly described herein, a method is provided which establishing communication with a customer regarding a current loan; accessing a customer service module; inputting loan information provided by the customer into the customer service module; and displaying a plurality potential loan options.

A system is also provided comprising a customer service database, the customer service database containing information with respect to at least one customer; a processor coupled to the customer service database, the processor accessing a customer service application; a communication network coupled to the processor, the communication network establishing communication with a customer regarding a current loan; a data entry device coupled to the processor, the data entry device inputting loan information provided by the customer into the customer service application; and a display device coupled to the processor; the display device displaying a plurality of potential loan options.

Also, a further method is provided which establishing a phone connection between a customer service representative and a customer regarding a current loan; accessing a customer service module, wherein the a customer service representative accesses the customer service module via a first interactive screen; inputting loan information provided by the customer into the customer service module; displaying a plurality of loan scenarios for a selected loan product based on the loan information, wherein the scenarios are generated by a preselected variations of the terms the loan product further comprising displaying those options on a second interactive screen that further displays a comparison of the current loan to the scenarios in a side by side format; and changing the scenarios base on variations of the terms of the loan product entered by the customer service representative.

Still further features and advantages of the present invention are identified in the ensuing description, with reference to the drawings identified below.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale and some of these elements are arbitrarily enlarged and positioned to improve drawing legibility. Further, the particular shapes of the elements as drawn are not intended to convey any information regarding the actual shape of the particular elements and have been solely selected for ease of recognition in the drawings.

FIG. 1 is a high level block diagram showing the environment in which the illustrated embodiments of the invention preferably operate.

FIG. 2 is a high level flow diagram of a method for marketing loan products to customers.

FIG. 3 is a high level flow diagram of a method for marketing loan products to customers.

FIG. 4 is a display diagram showing a sample loan selection page.

FIG. 5 is a display diagram showing sample cross sell selection page.

FIG. 6 is a display diagram showing a sample mortgage scenario page.

FIG. 7 is a display diagram showing a sample loan application entry page.

FIG. 8 is a display diagram showing a sample loan modification worksheet.

FIG. 9 is a display diagram showing a sample payment entry page.

### DETAILED DESCRIPTION OF PREFERRED EMBODIMENTS

In the following description, certain details are set forth in order to provide a thorough understanding of various embodiments of the invention. However, one skilled in the art will understand that the invention may be practiced without these details. In other instances, well known structures associated with networks, web servers, web clients, web pages have not been shown, or described in detail, to avoid unnecessarily obscuring descriptions of the embodiments of the invention.

Unless the context requires otherwise, throughout the specification and claims which follow, the word “comprise” and variations thereof, such as “comprises” and “comprising” are considered to be open, inclusive sense, that is as “including, but not limited to.”

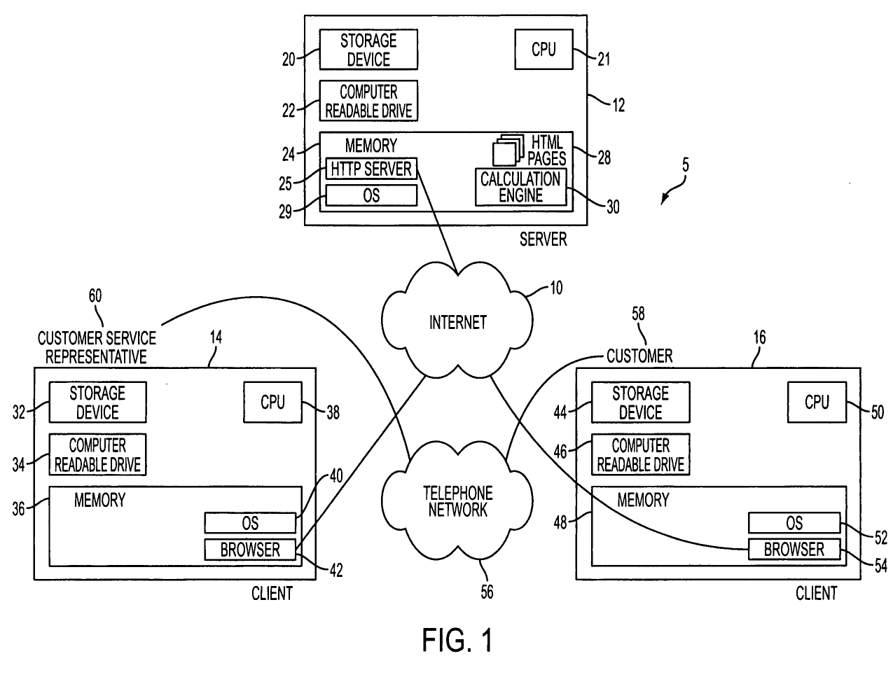

FIG. 1 is a high level block diagram showing an environment 5 in which the described embodiment of the invention can operate. In particular, FIG. 1 shows a network such as the internet 10 serving as a communication medium for a server 12 communicating with a first client computing device 14 and a second client computing device 16.

The server 12 includes a storage device 20, a central computing unit (“CPU”) 21, computer readable drive 22, and memory 24. The memory 24 of the server 12 includes instructions for responding a browser in the form of an HTTP server 25 for transferring HTML pages 28 to the client computing device 14 in response to a request from a browser, for example. Client computing device 14 may alternatively be connected directly to the server 12 though conventional means. The memory 24 also includes instructions for controlling the server's operation in the form of an operating system 29, and for calculating loan information in the form of a calculation engine 30.

The client computing devices 14 and 16 can take any of a variety of forms, including palm top or hand-held computing appliances, laptop or desktop personal computers, workstations or other computing devices. The client computing device 14 includes a storage device 32, a computer readable drive 34, a memory 36, and a CPU. 38 similar to the components of the server 12. The storage device 38 may take the form of a hard drive or other memory device. The computer readable drive may take the form of a floppy disk reader, CD-ROM reader, an optical disk reader, or similar device that reads instructions from a computer readable media.

The memory 36 can take the form of random access memory (“RAM”) or other dynamic storage that temporarily stores instructions and data for execution by the CPU 18. The memory 36 of the client computing device 14 also contains instructions for controlling the computing devices operation in the form of an operating system. The memory 36 of the client computing device 14 also contains instructions for communicating across the World Wide Web portion of the Internet 10 using standard protocol (i.e., TCP/EP) in the form of a browser 42. Browsers are commercially available, such as NETSCAPE NAVIGATOR or INTERNET EXPLORER.

The client computing device 16 includes a storage device 44, a computer readable drive 46, a memory 48, and a CPU. 50 similar to the components of the server 12. The storage device 44 may take the form of a hard drive or other memory device. The computer readable drive may take the form of a floppy disk reader, CD-ROM reader, an optical disk reader, or similar device that reads instructions from a computer readable media.

The memory 48 can take the form of random access memory (“RAM”) or other dynamic storage that temporarily stores instructions and data for execution by the CPU 50. The memory 48 of the client computing device 16 also contains instructions for controlling the computing devices operation in the form of an operating system. The memory 48 of the client computing device 16 also contains instructions for communicating across the World Wide Web portion of the Internet 10 using standard protocol (i.e., TCP/EP) in the form of a browser 54. Browsers are commercially available, such as NETSCAPE NAVIGATOR or INTERNET EXPLORER.

A telephone network 56 may be used to facilitate communication between a customer 58 and a customer service representative 60. Customer 58 and customer service representative 60 may communicate via a telephone, wireless network, or voice over internet connection or via a chat other internet communication medium. Client computing device 14 is associated with a customer service representative 60

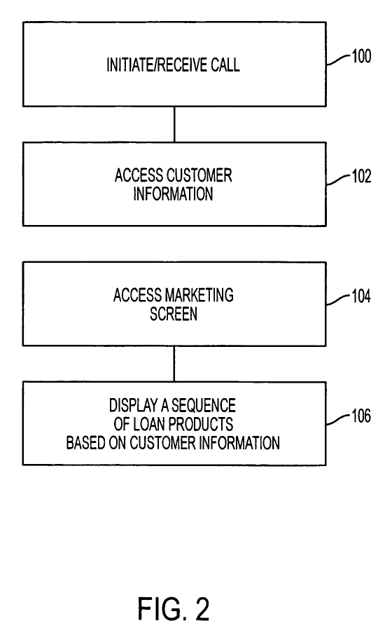

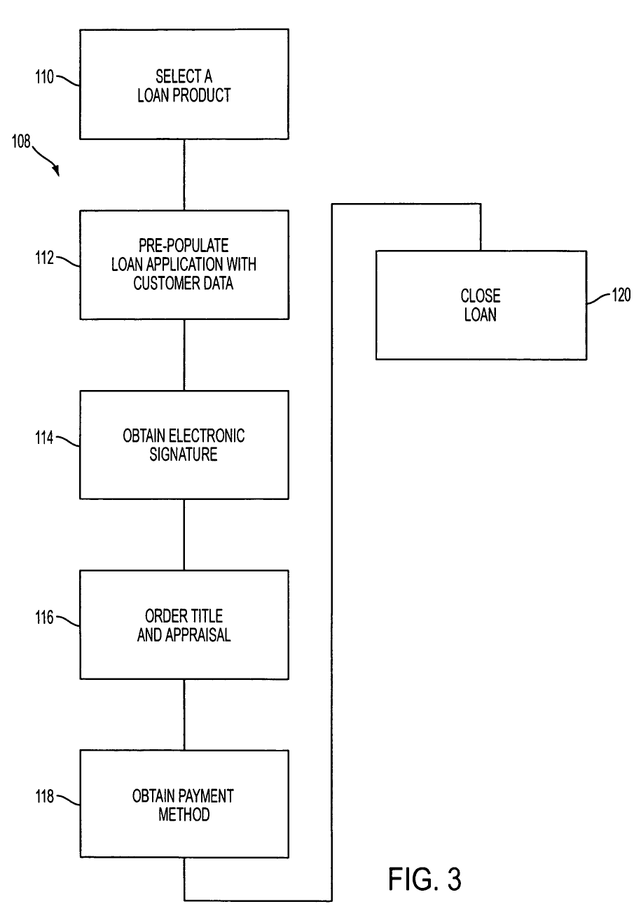

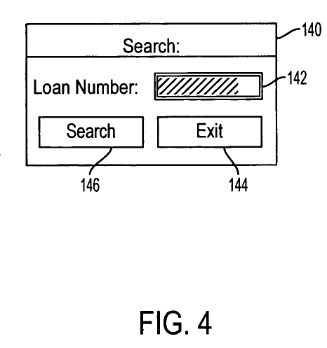

FIG. 2 shows a method 100 of marketing a loan product. FIGS. 2 and 3 will be discussed with reference to CPU 21 of the server 12 (FIG. 1), although one of skill in the art will recognize that the method could be also be performed on CPU 38 of the client computing device 38. Specific screens and apparatus for performing the methods in FIGS. 2 and 3 will be described below in association with FIGS. 4-9.

In step 102, the customer 58 and the customer service representative 60 establish a call. This call may be initiated by a customer in order to payoff an existing loan with the loan company 80. In this case the goal of method 100 is to stop the customer 58 from refinancing with a competitor of loan company 80. The customer may also initiate the call to buy a new home. The customer may also initiate the call for loan service. The customer service representative 60 may initiate the call in response to a service requests/inquiry. The customer service representative 60 may access customer information related to the existing loan such as monthly payment, loan balance and interest rate. A customer service module 101 (not shown) may be resident on computing device 12 or 14 and may provide customer service representative 60 information. Customer service module 101 may be a computer program or group of program modules.

In step 104, customer service representative 60 may access a marketing screen which allows him to target specific cross sell products 61 to the customer 58. Cross sell products 61 may be selected based on loan company 80's most popular products and/or customer qualifications. Cross sell products 61 may include Credit Cards, Home Equity Loans and other products. When the customer service representative 60 enters a loan number into the marketing screen a product may be identified that may interest the customer. This increases the opportunity that the right products are being offered to the customer during the call.

In a specific embodiment a customer service representative 60 may determine whether access the marketing screen based on a customers expressed desire to close a current loan. A customer service representative 60 may also be informed of the probability that the customer will close the current loan soon by the customer service module 101. This probability may be determined automatically by a computer process or manually by, for example, a marketing department. Factors in determine this probability may be high interest rate or high loan balance among others. Additionally, the customer service representative 60 may be informed that there is an alternate loan product or option which is beneficial to the customer. This information may be automatically supplied by customer service module 101 or solicited by the customer service representative 60 by accessing customer service module 101.

In a specific embodiment, the system may determine if the customer 58 is potential retention candidate. Factors used to determine if the customer 58 is a potential retention candidate include whether a payoff is being made, the customer's remaining loan term and the customer's interest rate. The system may prompt the customer care representative 60 to offer the customer 58 incentives such as: for a mortgage—refinance, i.e., beginning a new mortgage with a new term and interest rate or payoff, i.e., paying the remaining balance of a mortgage. (a necessary part of refinance); for Home Equity Line of Credit/Loan—better interest rate, i.e., lowering the interest rate on a line or loan; pay to zero, i.e., paying the outstanding balance of a line/loan; or end of access, i.e., extending the useable term of a credit line.

At step 106, the customer service representative may access a mortgage calculator that displays a plurality of loan products and/or scenarios. In a preferred embodiment, the customer service representative would select from a sequential list of preferred loan products. In such an embodiment, the mortgage calculator may present, for example, five different mortgage scenarios on a single screen based on the customer information accessed at step 102. Those of skill in the art will recognize that an appropriate number of scenarios may be displayed on this screen. Using this calculator, the customer service representative 60 may present these scenarios to a customer 58. The method described above allows for a customer service representative 60 to quickly access marketing information. A call with a customer is limited by the customer's patience. Previously, a customer service representative 60 would have to use a manual loan sheet and handheld electronic calculator, which was time consuming.

FIG. 3 shows a method 108 of applying for a marketed loan product 109 (not shown). At step 110, a customer service representative 60 may select a loan product identified in step 106. At step 112, the CPU 21 may pre-populate a loan application based on the loan information accessed in step 102. The customer may be given access this application at his browser 54. He may fill out any necessary additional information. At step 114, the customer may enter an electronic signature into the application. The electronic signature may be captured by any method available to those of skill in the art. At step 116, the customer service representative 60 may access a title and appraisal electronically. At step 118, the customer service representative 60 may obtain payment information. The customer service representative 60 may determine whether the customer is an existing customer via the system of the present invention. At step 120, customer service representative 60 may close the loan electronically. One such method of electronic closing is described in U.S. Patent Application No. ______ which is incorporated herein in its entirety by reference. Preferably steps 110-120 occur electronically during one call with a customer. In an alternative embodiment, the marketed product 109 may be any financial product including but not limited to: a home equity loan; credit card; auto loan; DDA account; investment loan product; IRA; stored value card related offer; or insurance.

In a specific embodiment of the invention, the customer 58 may perform steps 112-120 electronically by accessing the screens of the present invention without establishing a call with a customer service representative 60. In such an embodiment, the screens of the present invention would prompt the user with all information previously described as being presented by the customer service representative 60.

In association with FIGS. 4-9, sample screens for performing the method described above will be described. FIG. 4 is a sample screen 140 for entering a loan number as described in step 102. The customer service representative 60 may enter a loan number provided by customer 58 in the loan field 142. The customer service representative 60 may click on the “Search” icon 146 with will initiate a search for customer information regarding the loan number provided by the customer 58 which may be stored on server 12 in storage device 20. “Exit” icon 144 is provided to abort the loan search operation.

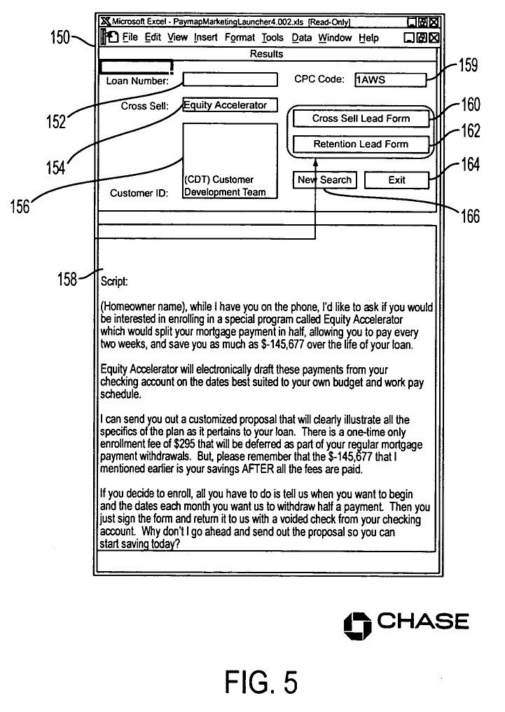

FIG. 5 is a sample screen 150 of a cross sell selection application. The cross sell selection screen 150 comprises a loan number field 152, a cross sell product field 154, a customer id field 156, a script field 158, a loan code field 159, a “cross sell lead form” icon 160, a “retention lead form” icon, an “exit” icon 164, and a “new search” icon 166. The loan number field 152 is populated with the loan entered in the loan entry screen 140. The customer id field 156 is populated with the customer's classification based on information retrieved from storage device 20. The script field 158 is populated with a script for the customer service representative 60 to follow during this portion of the call based on cross sell product identified in the cross sell product field 154. The loan code field 159 is populated with a customer categorization. One such category may be cross sell eligibility. The loan code 161 is a four digit code which may represent the type of customer and other characteristics of the customer. In one embodiment, the first two characters of the code may represent whether the customer is a retention customer. The cross sell product field 154 and loan code field 161 are populated by the system based on the type of loan entered and other factors associated with the particular customer such as product eligibility (which may be supplied for example by a Marketing department) and prior offer history.

According to a specific embodiment of the present invention, the “cross sell lead form” icon 160 may provide access to a cross sell subsystem 168 which captures information related to the customer service representative 60's attempt to cross sell on the call. This information may be used to reward the customer service representative 60 when the cross sell attempts are successful and to report on performance. Scripting 169 such as that provided in script field 158 may also be presented in the cross sell subsystem 168. Scripting 169 may guide the customer service representative through the call and provide telephone numbers relevant to the product being cross sold.

According to a specific embodiment of the present invention, the “cross sell lead form” icon 160 may provide access to a retention lead subsystem 169 which captures information related to retention leads as described above. This information may be used to reward the customer service representative 60 when the retention attempts are successful and to report on performance. Scripting such as that provided in script field 158 may also be presented in the retention subsystem 168. Scripting may guide the customer service representative through the call and provide telephone numbers relevant to the retention lead.

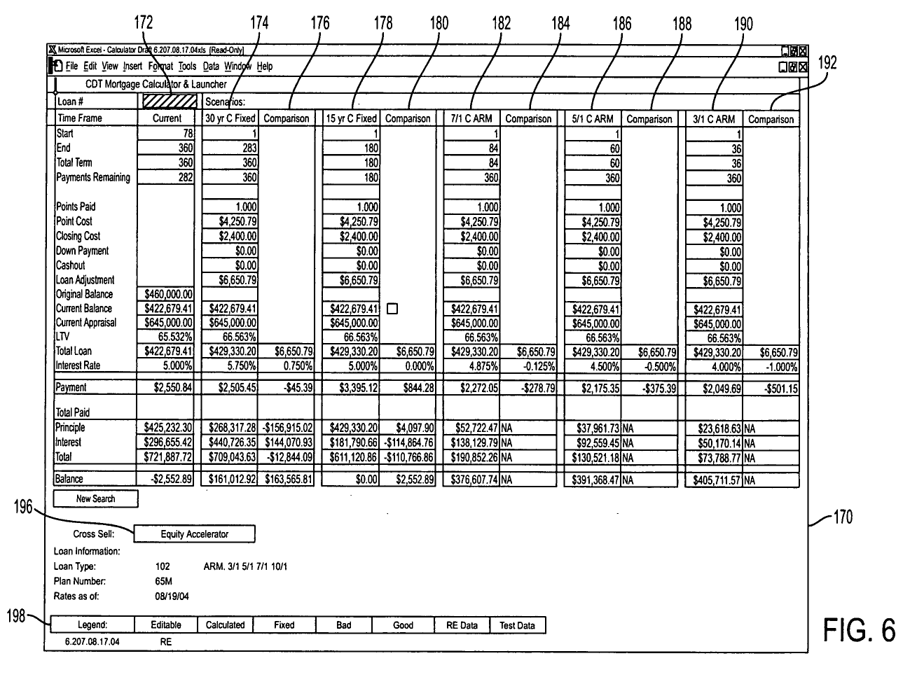

FIG. 6 is a mortgage scenario presentation screen 170. Sample mortgage scenario presentation screen 170 comprises a current loan column 172, loan scenario option columns 174, 178, 182, 186, 190, and comparison columns 176, 180, 184, 188, 192, loan information fields 196, and benefit to customer fields 194. The sample mortgage scenario presentation screen 170 eliminates the manual calculation of loan scenarios associated with prior methods. In a specific embodiment, sample mortgage scenario presentation screen 170 allows the customer to compare up to five different mortgage rate scenarios offered by the loan company 80 on one screen. Thus, the customer service representative can discuss the scenarios with the customer 58 immediately.

Current loan information such as the start, end, total term, payments remaining, points paid, points cost, closing cost, down payment, cashout, loan adjustment, original balance, current balance, LTV, total loan, interest rate, payment, total paid, principle, interest, total, and balance is displayed based on the loan number entered at step 102 is displayed on sample mortgage scenario presentation screen 170. Loan scenario option columns 174, 178, 182, 186, 190, and comparison columns 176, 180, 184, 188, 192 are displayed with the same information as the current loan information in order to facilitate comparison between the current loan and the scenarios. In keeping with the present invention, such information may be presented in any convenient format that will facilitate ease of comparing data and conveying the substance of the information to a customer. In a particular embodiment, the mortgage scenario presentation screen 170 can take into account the effect of a down payment amount in loan scenario option columns 174, 178, 182, 186, 190.

In a specific embodiment mortgage scenario presentation screen 170 contains a legend 198 which show which fields are editable, calculated, fixed, whether a field represents a good proposition for a customer or a bad proposition for a customer and whether data in a field was retrieved from a database. The indications may be represented by colors such as blue fore editable, clear for calculated, black for fixed, green for good, red for bad and yellow for a value retrieved from a database. Such visual indications allow the customer service representative to easily change the values of fields and quickly recognize when a new scenario represents a benefit to the customer. For example, if the interest rate in a scenario is better that the current interest rate the customer pays then that field may be turned green so the customer service representative quickly recognizes that fact.

In a specific embodiment of the present invention the scenarios may be changed by the customer service representative and the sample mortgage scenario presentation screen 170 will update the loan scenario option columns 174, 178, 182, 186, 190, and comparison columns 176, 180, 184, 188, 192 based on the newly selected scenarios. In another specific embodiment of the present invention the scenarios may be defaulted by the sample mortgage scenario presentation screen 170. For example, the sample mortgage scenario presentation screen 170 may present loan company 80's most popular loan products as the loan scenarios.

The benefit to customer fields 194 present to the customer the benefit of switching to a loan product represented by one of the scenarios. For example, the payment information such as principle and interest under the current loan and a particular loan scenario may be displayed side by side.

In an alternative embodiment, mortgage scenario presentation screen 170 may also be designed to present loan information from competitors of loan company 80. In this way, benefit to customer fields 194 can show the benefit of loan company 80's loan options over its competitor's loan options. One of skill in the art will recognize that actual rate information of competitors may be used in this embodiment and that such rate information can be obtained by conventional methods.

In a specific embodiment the client computing device 14 may include a screen that allows the entry of a competitor's loan product which is being contemplated by the customer. In this embodiment, client computing device 14 would display hidden fees associated with a competitor's loan product.

In a particular embodiment, mortgage scenario presentation screen 170 can be accessed via a URL address on the Internet. In this embodiment, email marketing my be sent to customers of loan company 80 which contain a link to the URL address for mortgage scenario presentation screen 170. In this way customer 58 can access mortgage scenario presentation screen 170 and determine if a loan company 80 loan product is beneficial to him. In this embodiment, the email marketing may be triggered by detecting a hit on an existing loan company 80 customer's credit representing a credit check by a competitor to loan company 80. In an alternative embodiment, the email marketing may be triggered by customer referrals.

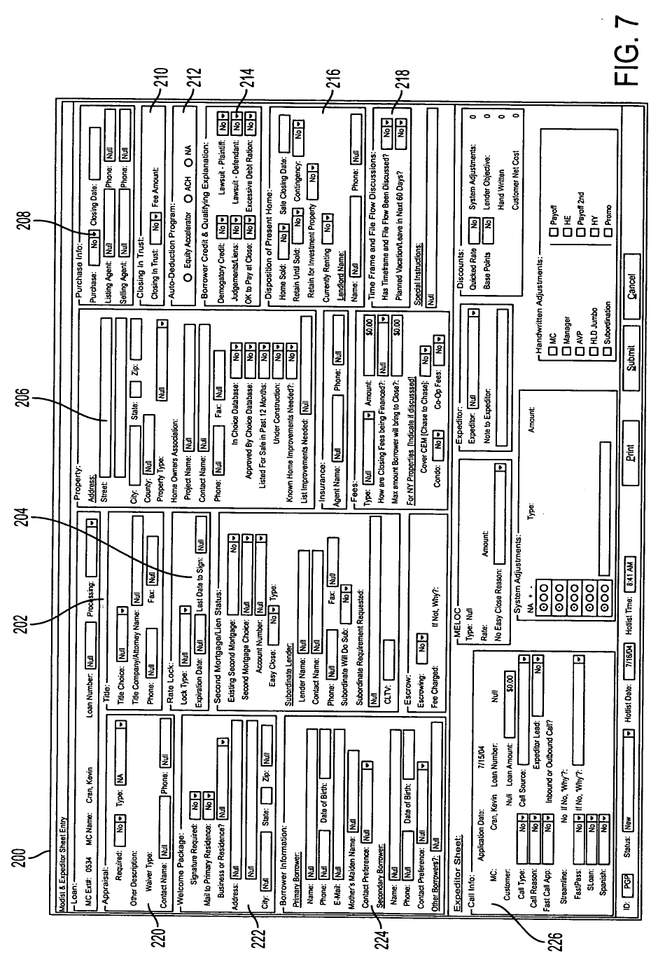

FIG. 7 is a sample screen 200 of a loan application entry screen. Sample loan application entry screen 200 contains fields relating to all information necessary to complete a loan application such as property type and location. One of skill in the art will recognize that a loan application may contain other information and may design a screen to include such information. One of skill in the art will also recognize that a loan application may contain information that cannot be entered electronically and leave such information off of loan application entry screen 200. Loan application entry screen 200 may also be used by the customer service representative as a summary screen to discuss loan information with the customer 58.

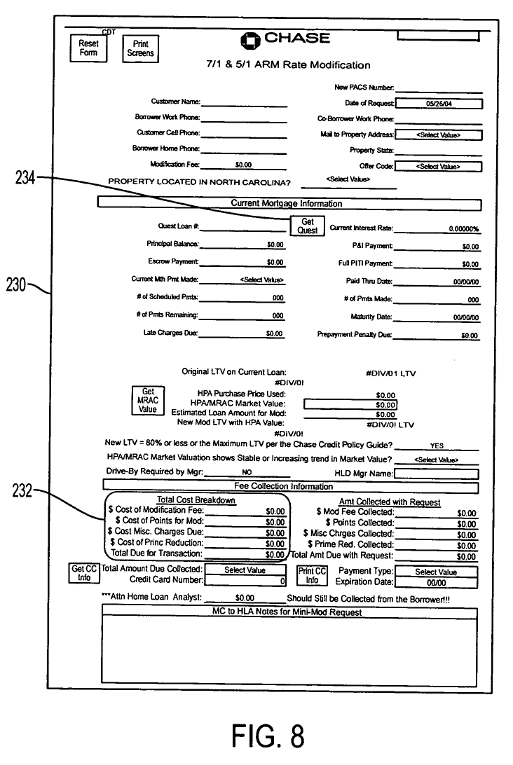

FIG. 8 is a sample screen 230 of a loan modification screen. Loan modification screen 230 comprises cost breakdown fields 232 and loan entry field 234. Cost breakdown fields 232 may present all fees associate with modifying a loan. Loan entry field 234 allows the entry of the customer 58's current loan number in order to retrieve loan information and avoid rekeying of information. Loan modification screen 230 can be used to pre-populate loan application entry screen 200. Loan modification screen 230 is used in lieu of traditional refinance screens of previous methods. In a particular embodiment the loan modification screen 230 may automatically perform a credit check to determine if the modification contemplated is feasible.

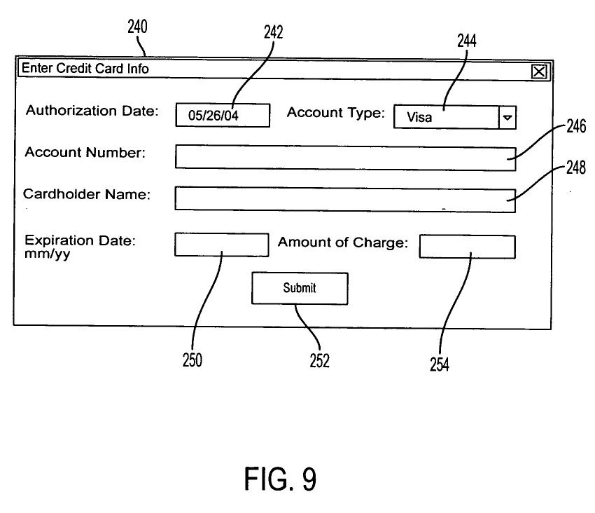

FIG. 9 is a sample screen 240 of a payment entry screen. Payment entry screen 240 comprises an authorization date field 242, an account type field 244, an account number field 246, a cardholder name field 248, an expiration date field 250, a “submit” icon and an amount of charge field 254. Payment entry screen 240 may be used to accept a conventional credit card payment for the loan applied for in steps 110-120. In an alternative embodiment, the customer service representative may access a screen to determine if the customer has an account with loan company 80.

Although specific embodiments of, and examples for, the article, apparatus, and method of the invention are described herein for illustrative purposes, various equivalent modifications can be made without departing from the spirit and scope of the invention, as will be recognized by those skilled in the relevant art. The teachings provided herein of the invention can be applied to other computing systems and other channels of communication. The teaching can also be applied to other products, other than loan applications. The various embodiments described above can be combined to provide further embodiments.

These and other changes can be made to the invention in light of the above detailed description. In general, the terms used should not be construed to limit the invention to the specific embodiments disclosed in the specification and the claims, but should be construed to include all automated systems that operate in accordance with the claims. Accordingly, the invention is not limited by the disclosure, but instead its scope is to be determined entirely by the following claims.

What is claimed is:

1. A method of marketing a loan product to a customer comprising:
establishing communication with a customer regarding a current loan;
determining a reason for the customer to close the current loan;
accessing a customer service module;
loading loan information provided by the customer into the customer service module; and
displaying a plurality potential loan options.

2. The method according to claim 1, wherein the reason to close the current loan is the customer's desire to close the loan.

3. The method according to claim 1, wherein the reason to close the current loan is determined by calculating the probability that the customer will close the current loan.

4. The method according to claim 1, wherein the reason to close the loan is found by determining that an alternative loan option is available to the customer.

5. The method according to claim 1, wherein the loan options are loan products.

6. The method according to claim 1, wherein the loan options are loan scenarios.

7. The method according to claim 3, wherein the loan scenarios comprise a plurality of loans each with a unique term.

8. The method according to claim 4, wherein the unique term is loan period.

9. The method according to claim 1, wherein the step of establishing communication further comprises establishing a communication via a web based application.

10. The method according to claim 1, wherein the step of establishing communication further comprises establishing a communication via a phone connection.

11. The method according to claim 1, wherein the step of establishing communication further comprises establishing communication between a customer and computer module.

12. The method according to claim 1, wherein the step of establishing communication further comprises establishing communication between a customer and customer service representative.

13. The method according to claim 1, further comprising the steps of:
completing an electronic application for one of the plurality of loan options.

14. The method according to claim 1, wherein the step of displaying further comprises displaying the options on an interactive screen that further displays a comparison of the current loan to the plurality of potential loan options.

15. The method according to claim 1, wherein the options displayed are selected by the customer service module based on the loan information.

16. The method according to claim 1, wherein the step of displaying further comprises displaying those options on a single screen.

17. The method according to claim 16, further comprising the step of:
changing one of the loan options, wherein the comparison of comparison of the current loan to the plurality of potential loan options is updated based on the change.

18. The method according to claim 1, wherein a first one of the plurality of loan options is offered by a first company and a second one of the plurality of loan options is offered by a second company.

19. The method according to claim 1, further comprising displaying a marketing script based on the loan information.

20. The method according to claim 1, wherein the displayed loan option comprises individually displayed loan terms and wherein one of the loan terms further comprises a visual indication that the loan term is beneficial to the customer.

21. A system for marketing a loan product to a customer comprising:
a customer service database, the customer service database containing information with respect to at least one customer;
a processor coupled to the customer service database, the processor accessing a customer service module, and wherein the customer service module determines a reason to close the current loan and wherein the processor loads loan information provided by the customer into the customer service application;
a communication network coupled to the processor; the communication network establishing communication with a customer regarding a current loan; and
a display device coupled to the processor, the display device displaying a plurality of potential loan options.

22. A storage medium storing programmatic code for marketing a loan product to a customer which, when executed performs acts comprising:
establishing communication with a customer regarding a current loan;
determining a reason for the customer to close the current loan;
accessing a customer service module;
loading loan information provided by the customer into the customer service module; and
displaying a plurality potential loan options.

23. A method of marketing a loan product to a customer comprising:
establishing a phone connection between a customer service representative and a customer regarding a current loan; receiving information that the customer is closing the current loan;
accessing a customer service module, wherein the a customer service representative accesses the customer service module via a first interactive screen;
loading loan information provided by the customer into the customer service module;
displaying a plurality of loan scenarios for a selected loan product based on the loan information, wherein the scenarios are generated by a preselected variations of the terms the loan product further comprising displaying those options on a second interactive screen that further displays a comparison of the current loan to the scenarios in a side by side format; and
changing the scenarios base on variations of the terms of the loan product entered by the customer service representative.
